(19) United States
(12) Patent Application Publication
(10) Pub. No.: US 2011/0087765 A1
(43) Pub. Date: Apr. 14, 2011

(54) NETWORK BANDWIDTH MANAGEMENT SYSTEM

(75) Inventors: Peter Musgrave, Dunrobin (CA); Philip Sparrow, Southampton (GB)

(73) Assignee: MAGOR COMMUNICATIONS CORPORATION, Ottawa (CA)

(21) Appl. No.: 12/575,666

(22) Filed: Oct. 8, 2009

(51) Int. Cl. G06F 15/16

(52) U.S. Cl. 709/224; 709/226

(57) ABSTRACT

A method is disclosed for managing bandwidth in a packet network carrying time sensitive data wherein sessions are established over virtual connections between respective pairs of endpoints. For at least some of the sessions, data representing local session bandwidth usage is sent over the network to a central server. The global bandwidth usage is monitored at the central server based on the local session bandwidth usage obtained from the data received from the endpoints. The central server sends messages to the endpoints to allocate bandwidth to the sessions in accordance with global bandwidth demands on the network.

### FIELD OF THE INVENTION

This invention relates to packet networks, and in particular to a method and apparatus for the management of bandwidth in such networks for the transmission of time-sensitive data, such as voice and video data.

### BACKGROUND OF THE INVENTION

It is becoming increasingly common to establish video conferencing sessions over IP networks rather than circuit-switched networks, such as ISDN. Such networks can, for example, be LANs, WANs, or virtual networks established over the Internet. In a typical session, a TCP/IP virtual connection is established between a pair of video endpoints, which can then communicate with each other to provide a telecollaboration session. The endpoints stream video and audio data to each other over additional virtual connections, typically RTP/UDP/IP.

A given video conferencing network has limited bandwidth and hence limits on the number of simultaneous video/audio flows that can be supported. These limits are not global, but depend on the network topology and the number of endpoints forming part of the teleconferencing system. If the limit has been reached or exceeded, then adding additional video calls to the network will result in a degraded video experience for all active video calls because the network will begin to discard packets in a non-deterministic manner. This situation can also arise when there is additional data traffic unrelated to the use of the video endpoints.

Network performance is becoming increasingly an issue as endpoints support high definition video, e.g. 1080 p. Improvements in encoding techniques, e.g. H.264, have reduced the average bandwidth for given video quality, but this is more than offset by increased use. Transmission impairments like latency, jitter & lost packets will likely remain characteristic of the Internet and other networks for the foreseeable future.

A video conferencing network is generally not under the control of the user of the video endpoints and as a result there is no way for the user to determine in advance if there is available bandwidth on the network or to determine when the network has become congested. Further more, available bandwidth will vary continuously over time in an unpredictable way. There may be more than sufficient bandwidth at the start of the session but this situation could change at any time during the session.

### SUMMARY OF THE INVENTION

Embodiments of this invention provide a mechanism for assessing the bandwidth availability in the network and ensuring that the available bandwidth is not oversubscribed. This mechanism ensures that several high quality video conferences may use the bandwidth resources of a video conferencing network instead of many conferences with poor quality and/or inadequate video.

According to the present invention there is provided a method of managing bandwidth in a packet network carrying time sensitive data wherein sessions are established over virtual connections between respective pairs of endpoints, comprising for at least some of said sessions, receiving data representing local session bandwidth usage over the network to a central server; computing global bandwidth usage data at said central server from the local session bandwidth usage data received from the endpoints; and said server sending messages to said endpoints to allocate bandwidth to said sessions in accordance with global bandwidth demands on the network.

The time sensitive data will typically be video since the invention is primarily applicable to video conference, but it could also be other data such as audio since the invention is also applicable to audio conferencing.

The network is preferably an IP network, such as a LAN, MAN, WAN or virtual LAN, in which case the virtual connections are preferably established as RTP/UDP/IP or TCP/IP sessions.

Embodiments of the present invention thus provide a solution to the bandwidth limit problem. One embodiment of the invention comprises a central server, referred to as a “Network Weather Office” or NWO, which communicates with each of the managed video endpoints. It is not a requirement that all video endpoints be managed but as more endpoints are managed the solution performance increases. A client on each of the video endpoints monitors the data throughput on existing video calls and reports the bandwidth used and packet loss to the central server. The client on each video endpoint requests video bandwidth from the NWO as part of the call establishment procedure and limits the video bandwidth (including no video) when the call is established based on the allocation received from the NWO.

The NWO collects the reports of existing bandwidth used by video endpoints and requests for new bandwidth and determines new bandwidth allocations for the existing and requested video calls.

In a further aspect the invention provides a bandwidth manager for a packet network carrying time sensitive data wherein sessions are established over virtual connections between respective pairs of endpoints, comprising a network interface for receiving data representing local session bandwidth usage over the network for at least some of said sessions; a processor configured to monitor global bandwidth usage based on the local session bandwidth usage obtained from the data received from the endpoints; and said processor being configured to send messages to said endpoints to allocate bandwidth to said sessions in accordance with global bandwidth demands on the network.

### BRIEF DESCRIPTION OF THE DRAWINGS

The invention will now be described in more detail, by way of example only, with reference to the accompanying drawings, in which:

FIG. 1 is a schematic diagram of a video conferencing network;

FIG. 2 is a block diagram of a modified endpoint in accordance with one embodiment of the invention;

FIG. 3 is a diagram illustrating a call setup procedure;

FIG. 4 is a schematic diagram of video conferencing system employing two distinct networks;

FIG. 5 is a block diagram of a central server (network weather office);

FIG. 6 is an example of a typical wide area network showing the various links;

FIG. 7 is a flow chart showing the client connection process;

FIG. 8 is a flow chart showing the server connection process;

FIG. 9 shows an exemplary connection sequence;

FIG. 10 is an example of a bandwidth allocation sequence;

FIG. 11a is an example of a system endpoint table;

FIG. 11b is an example of a link table;

FIG. 11c is an example of an allocation table; and

FIG. 12 shows an exemplary network topology.

### DETAILED DESCRIPTION OF THE PREFERRED EMBODIMENTS

Packet based Video transmission, in contrast to circuit switched video, is very demanding of the performance of the scarce and shared resources of the interconnecting data network. In contrast to one way video, e.g. movie broadcast, this is especially the case for a two way transmission of a video conference in which latency, or round trip delay, adds to the list of critical transmission impairments, e.g. others being jitter & lost packets. Video transmission is used as one example of the type of data stream to which the invention can be applied, although it will be appreciated that the invention is equally applicable to other forms of streaming data.

The way in which video transmission characteristics such as frame rate, resolution, and encoder bit rate may be adjusted to optimize the overall user experience in a given session is known in the art. A method to optimize the user experience of a given video conference throughout the session given the time variance of transmission impairments is taught in our co-pending patent application Ser. No. 12/489,977, the contents of which are herein incorporated by reference. This application teaches a method for smoothing data traffic by selectively delaying video i-frames from certain video sources in a way that does not unnecessarily increase the latency of high latency connections.

Embodiments of the present invention satisfy a need to further optimize performance of all transmission under the management of a central server, referred to as the Network Weather Office (NWO). For example, the scope of a NWO could include preferably all video endpoints at preferably all geographically dispersed offices of a company. Sessions so managed could be purely internal, e.g. a manufacturing company; or purely external, e.g. a conference service provider; or a combination of internal and external sessions.

The NWO will attempt to manage the user experience of all active sessions. In another embodiment the option is available according to predetermined policies to ensure certain sessions enjoy a better user experience than other sessions. This prioritization may be done, for example, on the basis of specific endpoints engaged in the session, e.g. board room system; or on the basis of participants, e.g. CEO is a participant. Further more such prioritization may take into account the schedule for such facilities or participants.

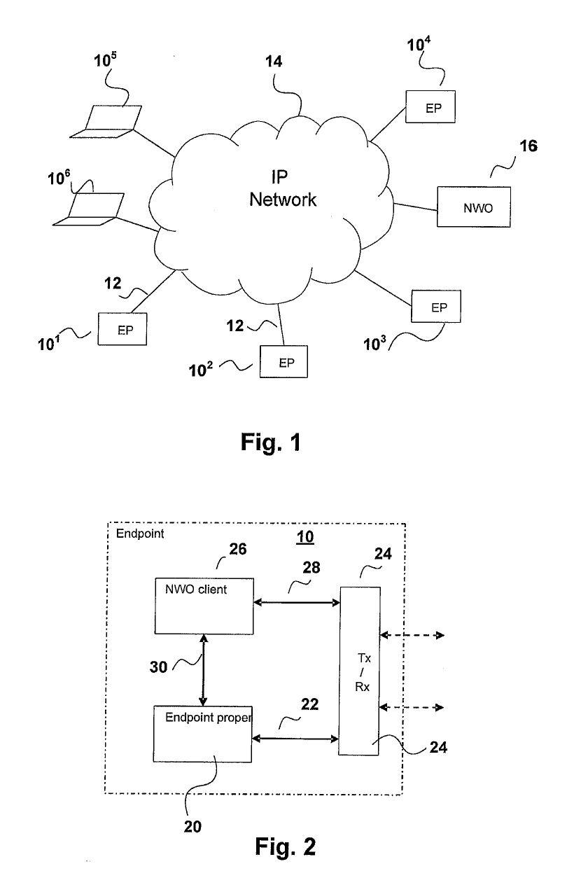

FIG. 1 shows a typical system of endpoints forming part of a video conferencing network. Endpoints 10¹ . . . 10⁶ are connected to IP network 14 over links 12. Endpoints 10¹, 10², for example could be video conference terminals, or simply audio conference units, between which a conference session is established. A session is established between these units when a call is set up using known methods (for example follows H.323 or SIP).

After the call is set up (complete) multiple IP connections will exist on the IP network between the connected endpoints. The IP network may comprise any interconnected combination of private and public networks (e.g. the Internet, Internet Service Provider, Corporate Network). Connections include some or all of audio media streams, video media streams, each typically two way (employing e.g. RTP/UDP connection), and administrative/statistical connection(s) (e.g. RTCP connection). It is understood that such endpoints may be a single component (e.g. cell phone) multiple components (e.g. typical of a conference room or office desk endpoint).

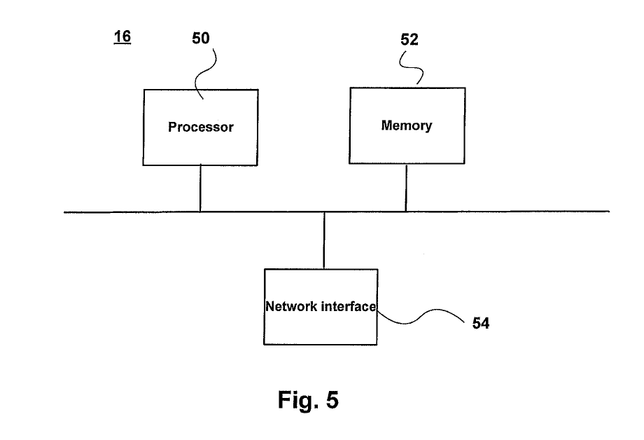

A central server known as the Network Weather Office (NWO) 16 is added to the system. The NWO 16 is connected to the network and uses an existing IP based protocol for communication with the endpoints 10¹ and 10² (e.g. XMPP, SIP). It is not necessary (or expected) for all endpoints to be connected to the NWO 16 but bandwidth management becomes more effective as more video endpoints are connected to the NWO 16. The central server 16 is shown in more detail in FIG. 5. It comprises a processor 50, a memory 52 for storing usage data, and a network interface 54 for communicating with endpoints over the network.

The NWO server 14 receives and sends messages, via IP connections, to each of the video systems, e.g. endpoints 10¹ and 10² deployed on the network. Video systems that are on active calls provide periodic reports to the NWO and indicate the amount of data they are sending and information on how much of this data has reached the far end. Typically networks have internal congestion control mechanisms that discard packets when the flow becomes too great. The reports provide a constant stream of data from which the NWO can infer bandwidth utilization. For example, if a call from endpoint 10¹ to endpoint 10² is trying to use 3 Mbps of bandwidth and all the packets are arriving with no losses then it is likely that the link has additional capacity. If there is significant packet loss on the connection, then allowing additional video calls on the link will result in the calls experiencing significant packet loss and poor quality. In the case of endpoints with adaptive video rates the endpoint will reduce the data flow to reduce the packet loss experienced on the link. This rate reduction can be provided to the NWO to indicate that the link is not running at the desired data rate.

Once the NWO 16 has detected a bandwidth limit it can employ one of several (configurable) options to resolve the issue:
1. Tell the video user requesting new bandwidth that no bandwidth is available and video cannot be used for the call. It may also queue the bandwidth request—so that when another calls stops the bandwidth can be allocated to this call.
2. Tell the video user requesting the bandwidth not to make the call at all.
3. Preempt the bandwidth allocated to another call (informing those clients to reduce their video bandwidth, possible to zero) to allow the new call to take priority

The bandwidth allocation reservation strategy employed can vary based on the network topology. Some networks have a total bandwidth limit while others will have a total bandwidth on sub-nets and have fixed links between sub-networks with a limit significantly lower than that of the sub-networks.

For example, in the embodiment shown in FIG. 4, there may be a sub-network N1 in North America with 100 Mbps service and a sub-network in Europe with 100 Mbps service, but they may be connected by a link 40 with 6 Mbps capability. In this case the NWO 16 will keep track of the usage in each sub-network and on the link 40. Bandwidth allocation decisions are then based on the composite knowledge of the network and link usage coupled with information about which resources a call between specific endpoints will require.

A call from North America to Europe requires bandwidth on both sub-networks N1 and N2 and the link 40, whereas a call between two North American video endpoints only requires bandwidth from the North American subnet N1. Once there are two 3 Mbps calls between North America and Europe, there is no additional bandwidth for further calls. Any new calls can either be denied video bandwidth, or the NWO 16 can reduce or remove an allocation from an existing user of the link. Similarly if there is one video call on the link but the video endpoints are reporting packet loss (or have reduced their bandwidth due to packet loss) then this indicates that there is traffic on the link from other sources. In this case there is no additional bandwidth available even though only one NWO 16 managed endpoint is using the link.

The specific bandwidth allocation strategy can include logic, which incorporates information such as specific network topology and endpoint location in the network, endpoint priority, user specified request priority (e.g. typical, important, urgent), and time of day schedules for bandwidth reservation.

The NWO 16 can also employ a bandwidth reservation policy based on time-of-day and specific endpoints to reserve bandwidth for specific calls in advance.

The network weather office does not need to communicate directly with any network equipment to determine network usage (although such information can be incorporated if available).

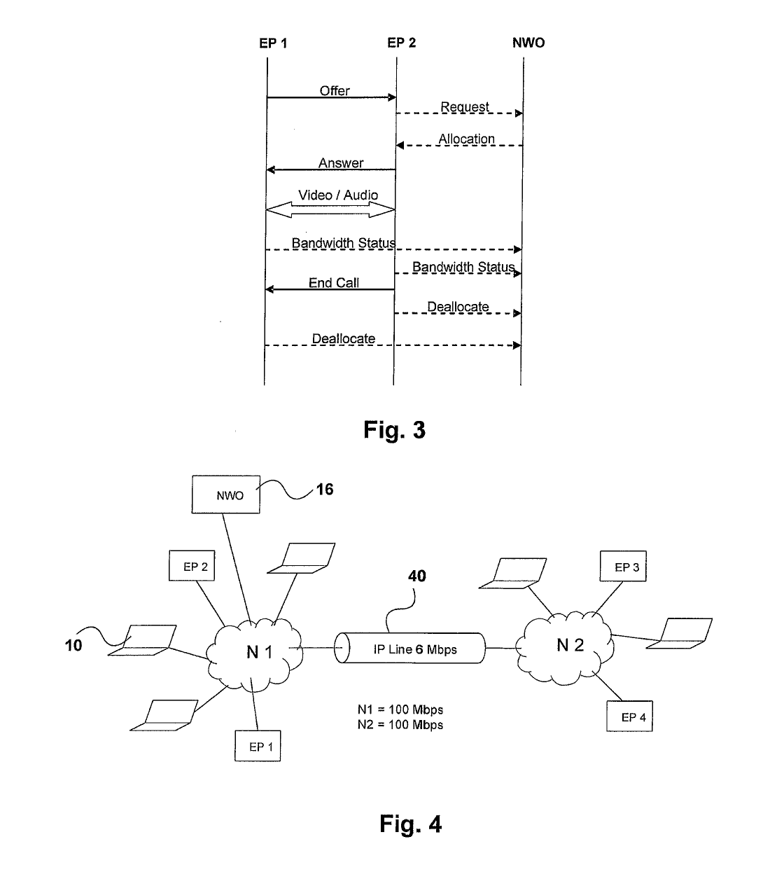

The existing call setup for video endpoints consists of an offer message, using the example of FIG. 1, from the calling party 10¹ to the called party 10² and a response message from endpoint 10² to endpoint 10¹. A sample message exchange is illustrated in FIG. 3. This initial message exchange provides a mechanism for the endpoints to offer a video stream and determine the other party's answer. The answering party examines the video offer (e.g. the specific CODECs offered), compares it to its own capabilities and selects a compatible video CODEC. Once this CODEC choice has been made the bandwidth required in each direction is known. In one embodiment of the invention, endpoint 10² can now contact the NWO 16 and request bandwidth for the video exchange between endpoints 10¹ and 10². The NWO 16 processes the request—examines its knowledge of the existing bandwidth usage and determines two allocations, one for video from endpoint 10¹ to 10² and another for video from endpoint 10² to 10¹. It then communicates this allocation to endpoint 10². Endpoint 10² indicates to its local video system how much bandwidth has been allocated. Endpoint 10² also provides information in the response to endpoint 10¹ indicating how much bandwidth endpoint 10¹ has been allocated to send to endpoint 102.

In cases where only one of endpoints 10¹ or 10² supports the use of the NWO 16, the endpoint that has contact with the NWO 16 can request video bandwidth for itself and on behalf of the other endpoint.

The bandwidth request to the NWO 16 can indicate both the desired bandwidth and the minimum acceptable bandwidth. This allows greater flexibility in the bandwidth allocation decision made by the NWO. Endpoints may initially be given the maximum requested but as additional bandwidth is consumed by other endpoints the NWO 16 may reduce the bandwidth allocation to an endpoint during a call.

FIG. 2 depicts a typical endpoint 10 adapted for use with the NWO server 16. The endpoint proper 20 represents any endpoint implemented using known methods. In a conferencing environment, it would be the video equipment. The endpoint proper 20 is connected over link 22 to the network transmitter/receiver (Tx/Rx) block 24. The Tx/Rx block 24 represents the “stack” implementing all protocols required for connection to distant endpoint 10. e.g. TCP, UDP, IP, RTCP etc. The connection, typically internal to a device, is implemented using any method suited to the operating environment. It will be understood that the Tx/Rx functions could be fully integrated into the endpoint proper 20.

The endpoint also includes NWO client 26. The client 26 also uses the stack 24 to communicate with the NWO 16 typically using TCP/IP protocol. It will similarly be understood that the stack 24 could be fully integrated into the NWO client 26 and that the, typically internal, connection can be implemented using any method suited to the operating environment. Typically internal communication 30 between the client 26 and endpoint proper 20 is again implemented using any method suited to the operating environment, e.g. endpoint Applications Programming Interface (API).

The modified endpoint of FIG. 2 may take various hardware forms, including being fully implemented within a single PC, (e.g. a desktop) or be in the form separate components (e.g. a conference room). In the latter case the preferred connection 30 would also be TCP/IP.

During an existing video call the video system tracks the video data sent and collects information from the far end that allows it to determine the packet loss using known methods, e.g. RTCP. This information is collected and sent by client 26 periodically to the NWO 16. If the video system detects packet loss, using known methods (such as RTCP) it will typically lower the bandwidth from the video sender and attempt to find a rate at which the data loss becomes very small or stops. This provides the NWO 16 with a steady stream of information about the general network usage as well as up to date information about ongoing video calls.

As additional requests are made to the NWO 16 it may elect to reduce or withdraw the bandwidth allocated to endpoints based on the bandwidth allocation strategy. This is accomplished by sending a bandwidth allocation message from the NWO 16 to the affected endpoints.

Update messages from the client 26 are also sent when the bandwidth used changes (e.g. if an endpoint reduces the size of a viewer the sender bandwidth may be reduced dynamically). When the call is concluded or the video is stopped the endpoint indicates to the NWO 16 that the bandwidth allocation is no longer required.

The following discussion explains in more detail the operation of the system.

### Bandwidth Requests and Allocation

In FIG. 2, endpoint clients 26 will request bandwidth for all video streams that are needed, for example, when other endpoints are connected to or disconnected from the call in progress at each managed endpoint. Requests for bandwidth sent to the NWO sever 16 are responded to with either Allocation, Queued or Denied messages.

The Request message specifies the preferred and minimum bandwidth for the allocation; no more bandwidth should be allocated than the preferred amount and the minimum bandwidth specifies the minimum bandwidth acceptable for the video stream to be of acceptable quality.

The Allocation message indicates that the request has been allowed for immediate use with the bandwidth specified in the message; this bandwidth specification will be between (and include) the preferred and minimum bandwidth specified in the request.

The Queued notification message indicates that there was no space on the network to allocate bandwidth for the Request; if any bandwidth was available for allocation, it was below the requested minimum. The Queued request will be allocated as soon as other allocated video streams have ended or when the bandwidth required for existing allocated video streams is reduced.

A Denied message indicates that the minimum bandwidth specified in the Request was impossible to allocate on the network because maximum bandwidth across the network was is less than the minimum bandwidth requested.

An endpoint can change the details of an allocation request at any point, which would be useful if the amount of bandwidth needed for a video stream is reduced, for example, because the viewer for a video using Spatial Scalable Video (Application 61/243,277) has been reduced or expanded and the bandwidth requirements have changed.

When sending or receiving video streams, managed endpoints 10 (more precisely NOW client 26) report the bandwidth statistics to the NWO periodically. These Report messages can be used to help the NWO 16 determine the actual bandwidth being used for video across the network.

Some Reports will be more useful than others: e.g. a report for video between two endpoints in the same location, with a 100 Mb/s connection would be of less interest (with respect to network congestion) than a report for video between two endpoints that are traversing multiple links in the network if the links only have 3 Mb/s bandwidth.

Reports from both the sender and receivers of video streams may be useful to the NWO: if the receiver reports that it is receiving data at a lower bit rate than the sender reports sending out the data, the NWO can determine that data is being lost in the network, which would likely be due to over-subscription on the network links. It is known to dedicate network links to video, but it is an objective of this invention to allow video to share links with all other types of traffic. In the case, for example, of a NWO managed video stream being transmitted over the public Internet. This over subscription could be caused by any type of data an Internet user is sending over the Internet.

An End message from a client 26 will indicate that the stream is no-longer being used and the Allocation can be removed from the NWO Server 16. In this case, the free space can be offered to allocate Queued requests and/or increase the bandwidth allocated to existing Allocations. The NWO Server 16 may send an End message to a Client if Report messages have not been received before the negotiated Report time interval (agreed by the Configuration negotiated, see below).

### Connecting to the NWO Server

Clients 26 connect to the NWO Server 16 by agreeing upon a configuration with the server. This configuration details the time interval for allocation reports between the connecting endpoint and other known endpoints. It is desirable to send less important Report messages to the NWO 16 less frequently; the relative importance of a Report message is determined by the number of links traversed by the Allocation and the maximum bandwidth available over these links. i.e. an Allocation between two systems on the same network Node (explained below) should have bandwidth Report messages sent to the NWO Server less frequently than an Allocation that spans across the entire network and travels over multiple (possibly low bandwidth) links.

Reports for an Allocation for video between New York and Paris (see NWO Network example & Table 4, Call 1) would be of more use for the NWO Server to determine the amount of traffic over the network than Reports for an Allocation between two systems both in Amsterdam.

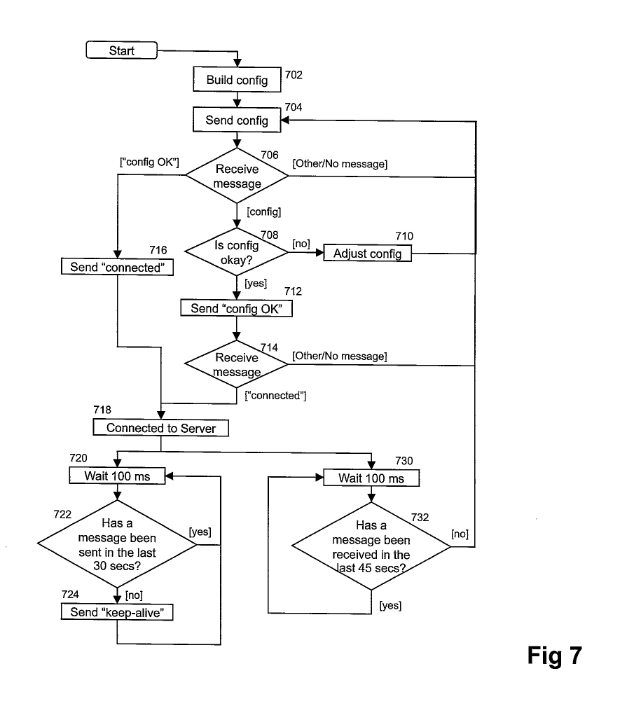

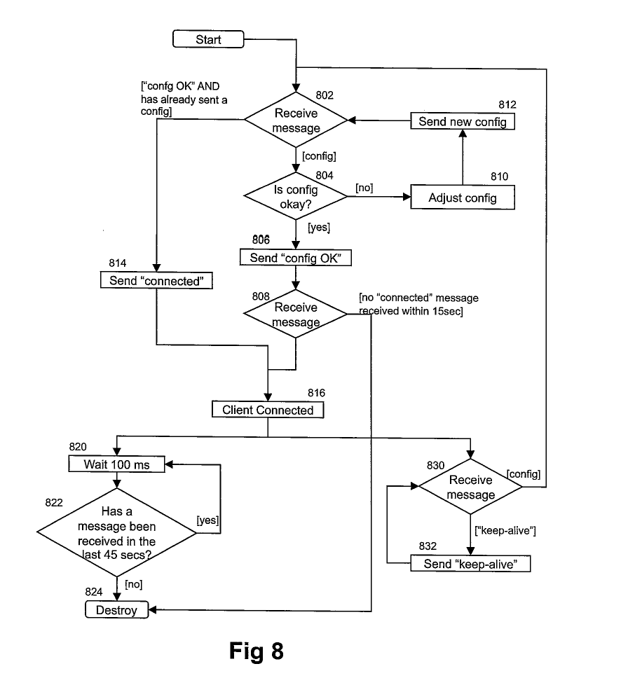

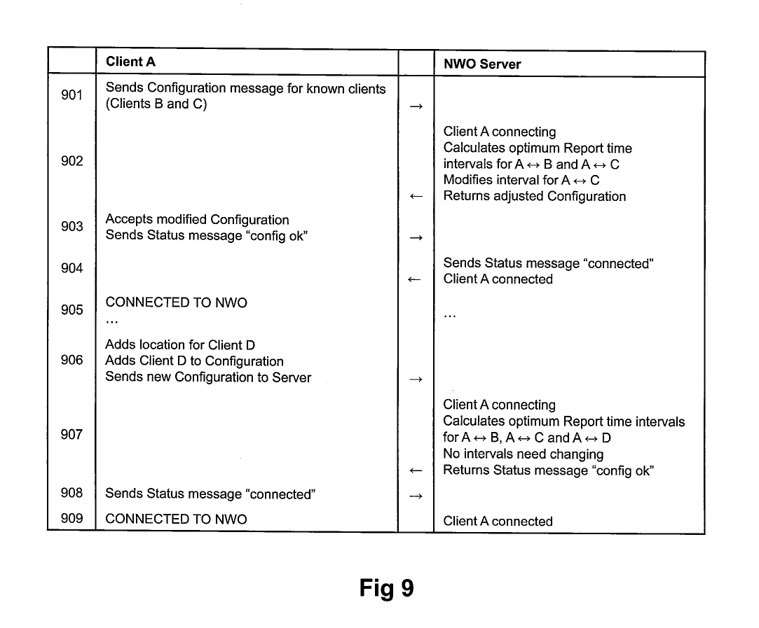

Simplified flow charts for one embodiment of the NWO Server 16 and a Client 26 are shown in FIG. 8 and FIG. 7 respectively. The following example further illustrates their operation in the sample connection shown in FIG. 9

A Client 26 sends the configuration message 702, 802 & 901 to the NWO 16, which in turn calculates the optimum report intervals for each Client specified in the configuration. If the Client-specified intervals are close enough to the optimum report intervals (e.g. the values are within 10%) 806 then the Server's response to the Configuration message is with a Status message to indicate that the configuration sent by the Client has been accepted 810. Upon receiving this acknowledgement 706, the Client replies with a Status message to indicate that the Client is now connected to the Server 716.

If the initial Configuration message from the Client is not accepted by the Server 806, the Server sends the Configuration back to the Client with any relevant modifications 808, 804 & 902. The Client will then accept 706, 708 & 903 the returned Configuration and return the Status message that the Configuration sent by the Server has been accepted 712. Upon receiving this acknowledgement 802, the Server replies with a Status message to indicate that the Client is now connected to the Server 814 & 904.

If the client adds a new location to its list of known locations, it must be added to the Configuration and this must in turn be negotiated with the Server again. Existing allocations do not need to be re-requested during this reconnection.

### NWO Network

The NWO Server 16 does not need to be aware of the exact topology of the underlying network (especially the physical connections), but knowledge of relevant links is important.

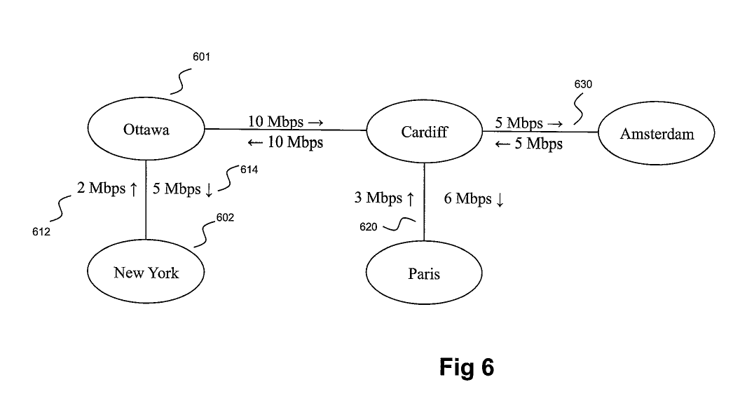

An example of such a Wide Area Network with various links is illustrated in FIG. 6. As will been, this comprises:
Nodes: e.g. Ottawa 601, New York 602, etc.; and
Links: e.g. a two way link between Cardiff and Amsterdam 630

The links can be asymmetric. For example, on Link 620, Paris is connected to the network by a 6 Mbps downlink and a 3 Mbps uplink.

### NWO Server Request Allocation and Allocation Adjustment

To optimize the number of video streams that can be sent over a network simultaneously, the server 16 must know the location of the sender and the receiver, where the location will be a node on the network. Each node can have zero or more endpoints and a video stream will often traverse many links and nodes in the network.

If one or more Allocations are using a particular Link and there is not enough space for a new Request to be allocated, the existing video streams could have their bandwidth reduced (but not below the minimum bandwidth specified in the Request) to accommodate the new Request.

It may be desirable to give specific endpoints a greater chance of receiving high-quality video streams, i.e. the receiver of an allocated video stream. This introduces the notion of prioritization.

A Request of higher priority than the priority of an existing Allocation should be allocated proportionately more bandwidth than the existing Allocation.

### EXAMPLE

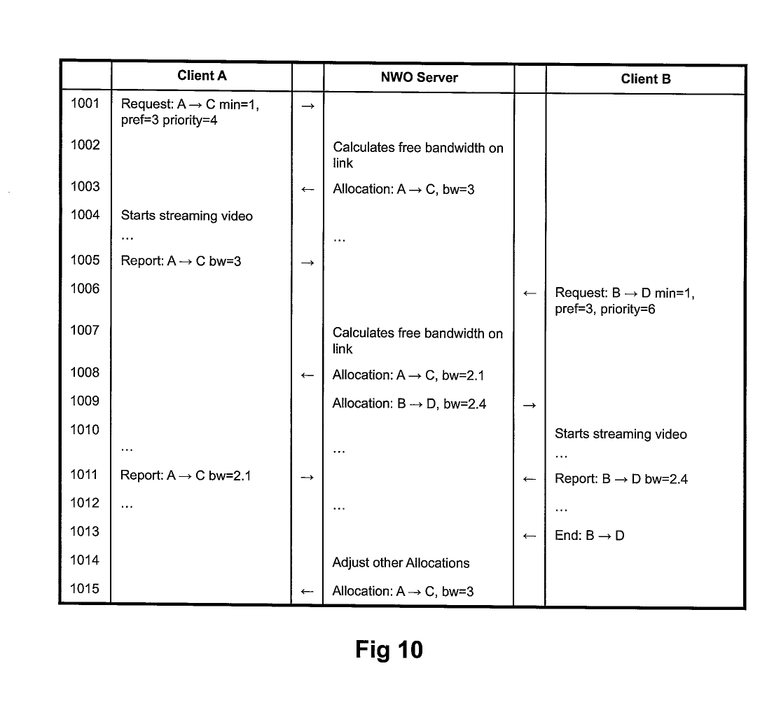

In FIGS. 6 and 10, Ottawa 601 has endpoints: A and B and New York 602 has endpoints C and D.

A Requests bandwidth for A→C.

Request: Minimum=1 Mbps, Preferred=3 Mbps, Priority=4 FIG. 10—1001

NWO Allocates 3 Mbps for A→C FIG. 10—1003

B Requests bandwidth for B→FIG. 10—1006

Request: Minimum=1 Mbps, Preferred=3 Mbps, Priority=6

In this case, the NWO cannot allocate 3 Mbps for both A→C and B→D because the Link 614 can only support a total of 5 Mbps. Both Allocations can be allocated as little as 1 Mbps, but B→D is of higher priority and as such, should be allocated proportionately more bandwidth than A→C.

A→C is (re)allocated: 2.1 Mbps (it was 3 Mbps before) FIG. 10—1008

B→D is allocated: 2.4 Mbps FIG. 10—1009

B Ends its allocation for B→D FIGS. 10—1013

The NWO 16 now has 2.4 Mbps of bandwidth that can be allocated to Queued requests or Allocations that have been reduced (i.e. A→C).

A→is (re)allocated: 3 Mbps (it was 2.1 Mbps before) FIGS. 10—1015

It will be seen that these allocations use the link between New York and Ottawa most efficiently.

### Network Impairment Handling

If the NWO 16 loses network connectivity, Requests from Clients for bandwidth allocation may not reach the Server. Clients 26 which do not receive an Allocation, a Queued or a Denied message will self-allocate under the assumption that the Server would have allocated bandwidth. Upon reconnecting to the Server, the clients will send the results of any self-imposed actions, such as self-allocations, back to the Server to ensure the NWO has accurate knowledge of the video stream traffic being sent across the network.

Clients will stay connected to the Server by sending and receiving messages to ensure that the connection is alive FIG. 7 724 & FIG. 8 832. If no useful messages (such as Requests, Allocations and Reports) need to be exchanged with the Server, keep-alive messages will be exchanged.

It will of course be appreciated that the time values given in FIG. 7 blocks 720, 722, 730 & 732 and FIG. 8 blocks 820 & 822 are all examples of the values that may be used in one embodiment of the invention. Persons skilled in the art will appreciate that any suitable value could be used.

### Optimized Bandwidth Allocation Strategy

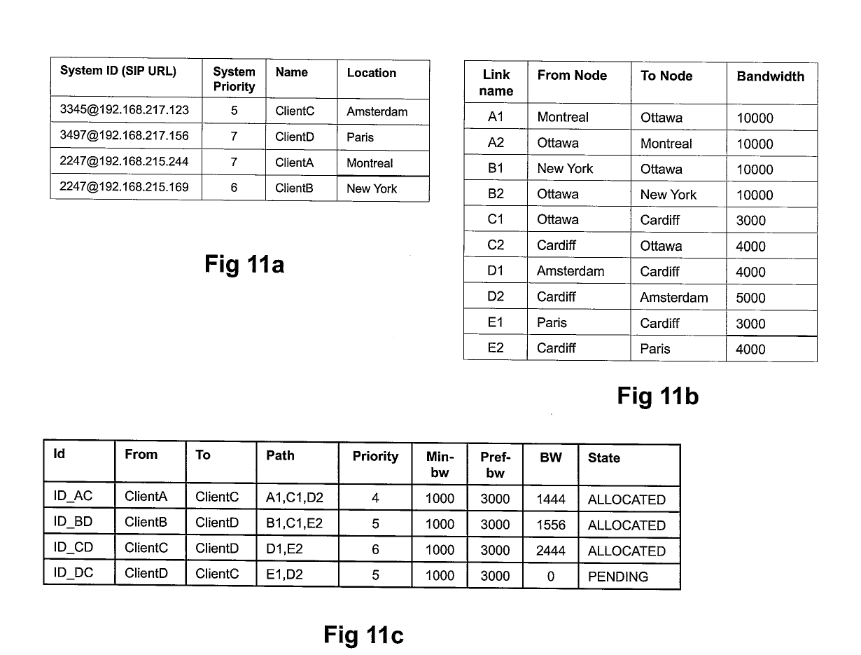

In one embodiment the NWO contains an Allocation Table, an example of which is illustrated in FIG. 11c.

Table rows (allocations) are added when a Requesting System (e.g. video endpoint) first requests bandwidth for a specific data stream one way between specified locations. The Requesting System could be one of the sending endpoint, the receiving end point or a third system. In the case of bidirectional data streams such as video, a single system could request bandwidth for both transmission directions. In one embodiment the Requesting System is the called party system. The called party system makes two requests: one for the stream it will transmit to the calling party system; another for the stream it will receive from the calling party system. Any allocation message received from the NWO for the receiving stream bandwidth will be forwarded in a message to the calling party system using call control protocol (e.g. SIP methods).

Video is an exemplary data stream and a typical video conference connection involves two such data streams, one in each direction e.g. allocations ID_CD and ID_DC in the table. Such an initial request could, for example, come from a video endpoint wishing to send or receive video data.

Table rows are removed when the allocation is no longer required, e.g. when the associated video conference ends.

As the NWO receives Bandwidth Requests the Allocation Table is updated.

In the illustrated example, the Allocation Table contains the following columns:
1. Id: An arbitrary unique identifier of a specific one way data stream.
2. From: The name of the system (see System Table below) originating the data stream.
3. To: The name of the system (see System Table below) to which the data stream is destined
4. Path: A list of links (see Link Table below) via which the stream passes, e.g. FIG. 6, 612
5. Priority: A priority assigned to the data stream by the Requesting System (see System Table below). This value could change during the life of the data stream
6. Minimum Bandwidth: in kbps a value specified by the Requesting System, see Bandwidth Requests and Allocation.
7. Preferred Bandwidth: : in kbps a value specified by the Requesting System, see Bandwidth Requests and Allocation.
8. BW: Is the bandwidth in kbps currently allocated by the NWO to the “From” system for the data stream.
9. State: is the NWO internal State of the Allocation algorithm including ALLOCATED; QUEUED; and PENDING.

Two other relatively static tables, referenced above, are required by the allocation algorithm: a System Table and a Link Table. It will be understood that such tables may in fact simply represent data the NWO retrieves from a database which may or may not part of the NWO.

An exemplary System Table (Endpoint Table) is Illustrated in FIG. 11a and contains the following columns:
1. System ID: the address, unique to the network managed by the NWO, of a managed system. In one embodiment this is the SIP URL of the system or endpoint.
2. System Priority: Priority value used by the allocation algorithm as described below. In the example embodiment the higher the number the higher the priority. Priority assignment is beyond the scope of this invention. The priority levels could be specified by the end user, or could be stored centrally by the NWO Server to prevent abuse by end-users, or an overall priority could be calculated and used by the NWO based on local and client-provided data.
3. Name: An arbitrary name, unique to the network managed by the NWO, given to a system. The Name is typically selected to be meaningful to system maintenance personnel but could in fact be the System ID.
4. Location: The physical location of the system. It is one of the nodes listed in the Link Table.

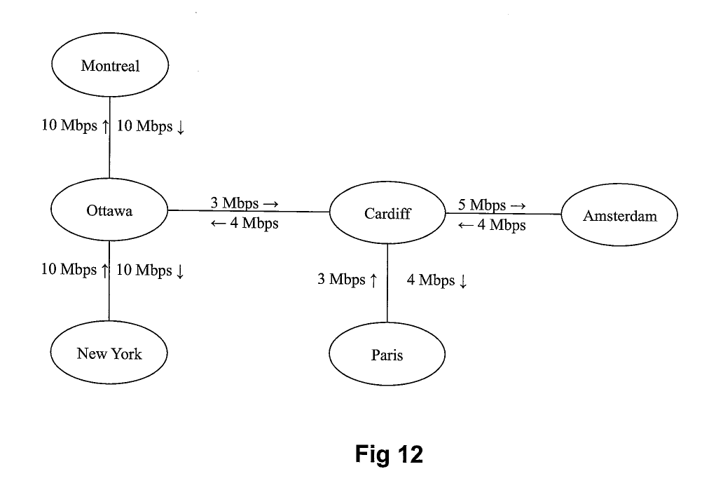

An exemplary Link Table is Illustrated in FIG. 11b. The Link Table describes the topology of the network managed by the NWO. This table is built by methods that will be known to persons skilled in the art. The example network illustrated in FIG. 12 is stored by the NWO in the Link Table FIG. 11b and contains the following columns:
1. Link name: An arbitrary name assigned to the link between two nodes carrying data in a given direction
2. From Node: An arbitrary name assigned to the network node from which data can be sent via the link.
3. To Node: An arbitrary name assigned to the network node to which data can be sent
4. Bandwidth: Bandwidth available to the NWO for assignments. This may be less than or equal to the actual bandwidth of the link.

In one embodiment of the invention the following algorithm is used to allocate bandwidth to each data stream.

Allocations are analyzed one by one, starting with the highest priority first; for equal priorities, allocations that are in state=QUEUED will take precedence over PENDING, which will take precedence over ALLOCATED; for allocations with matching priority and matching state, the lowest ID string will take precedence. This ensures deterministic ordering and predictability.

For each allocation, it is first necessary to find out how much bandwidth can be allocated; if enough bandwidth is found, the allocation will be set to state: ALLOCATED (if it was in PENDING or QUEUED or ALLOCATED); if not enough bandwidth is found, the allocation will be set to QUEUED (if it was in PENDING before). Allocations in state: PENDING will always move to ALLOCATED or QUEUED, and once set to ALLOCATED, an allocation can never be moved back to QUEUED.

Variations of the algorithm allow an ALLOCATED allocation to be moved back to QUEUED. This would allow the NWO to pre-empt a previous bandwidth allocation if a higher priority user or endpoint is attempting to set up a new call on a link with insufficient bandwidth for the new call.

Once an allocation has finished being analysed (adjusted or not), it cannot be adjusted again when other allocations are analysed in turn.

Each allocation will traverse a list of network links (of known bandwidth) and a minimum bandwidth must be maintained (i.e. once in status: ALLOCATED, the allocation will always be in ALLOCATED and cannot be changed to QUEUED).

To find out if a PENDING allocation can be allocated, at least the minimum bandwidth must be available on all of the links traversed. If this cannot be allocated, the allocation goes into status: QUEUED; in subsequent analyses of this allocation, the bandwidth may become available and the allocation will change to status: ALLOCATED.

When calculating the amount of bandwidth free to allocate to the currently analysed allocation, the links in the allocation are analysed individually. On each link, the allocations that use it are analysed. By calculating the minimum amount required by each allocation, the total minimum can be found and thus the maximum amount free will be known.

The minimum amount required by each allocation depends upon the status of the allocation: PENDING and QUEUED allocations have a minimum of zero, since they are not allocated yet; ALLOCATED allocations have a minimum of the minimum requested bandwidth [from NwoRequest sent by the client], [since ALLOCATED allocations can never be changed to QUEUED and they have to have at least this minimum allocated at all times].

With the maximum free known, an appropriate proportion must be calculated for this allocation. The proportion is worked out from the ration of the allocation's priority to the total of all priorities for allocations that have status: ALLOCATED.

This assumes that the other allocations will take the entire amount for their portion, but this is not accurate, because that allocation may be limited by a different link. As such, the amount allocated is an assumption; once all allocations have been adjusted, there may be some free space so the allocations are analysed (in the same order) and are expanded to fill any free space available.

The following represents the log of an actual implementation of the invention showing the manner in which the allocations were made in this particular case:

### Adjustments:

Allocations:

ID_AC: Path=A1,C1,D2; P=4; minBW=1000; State=ALLOCATED; bw=1444

ID_BD: Path=B1,C1,E2; P=5; minBW=1000; State=ALLOCATED; bw=1556

ID_CD: Path=D1,E2; P=6; minBW=1000; State=ALLOCATED; bw=2444

ID_DC: Path=E1,D2; P=5; minBW=1000, State=PENDING; bw=0

Sorting:

ID_CD: Path=D1,E2; P=6; minBW=1000; State=ALLOCATED; bw=2444

ID_DC: Path=E1,D2; P=5; minBW=1000, State=PENDING; bw=0

ID_BD: Path=B1,C1,E2; P=5; minBW=1000; State=ALLOCATED; bw=1556

ID_AC: Path=A1,C1,D2; P=4; minBW=1000; State=ALLOCATED; bw=1444

Analysing:

1. ID_CD:
Analysing allocation:
NwoRequest: id=IDCD ClientC to ClientD (Min: 1000 Pref: 3000 kbps, P=6)
NwoAlloc: id=IDCD bw=2444 st=ALLOCATED
Using path: D1,E2,
New bw: 3000 (pref-bw, will never go above this but will be reduced during analysis)
   Link D1:
      Found 1 allocation(s) on link:
      Allocation IDCD:
         Has not been adjusted: adding priority (6), minimum bandwidth will be taken as minimum (min-bw=1000)
      Total min used=1000, Max available=4000
      Max free=max available−total min used=3000, Total priority=6, Min bw=1000
      Proposed BW=(allocation.priority*max free/total priority)+min-bw=4000
      New BW=min(newBw, proposedBw)=min(3000, 4000)=3000
   Link E2:
      Found 2 allocation(s) on link:
      Allocation IDCD:
         Has not been adjusted: adding priority (6), minimum bandwidth will be taken as minimum (min-bw=1000)
      Allocation IDBD:
         Has not been adjusted: adding priority (5), minimum bandwidth will be taken as minimum (min-bw=1000)
      Total min used=2000, Max available=4000
      Max free=max available−total min used=2000, Total priority=11, Min bw=1000
      Proposed BW=(allocation.priority*max free/total priority)+min-bw=2091
      New BW=min(newBw, proposedBw)=min(3000, 2091)=2091
Allocation adjusted: (new bw=2091, old bw=2444)

2. ID_DC:
Analysing allocation:
NwoRequest: id=IDDC ClientD to ClientC (Min: 1000 Pref: 3000 kbps, P=5)
NwoAlloc: id=IDDC bw=1000 st=PENDING
Using path: E1,D2,
New bw: 3000
   Link E1:
      Found 1 allocation(s) on link:
      Allocation IDDC:
         Has not been adjusted: adding priority (5), minimum bandwidth will be taken as minimum (min-bw=1000)
      Total min used=1000, Max available=3000
      Max free=max available−total min used=2000, Total priority=5, Min bw=1000
      Proposed BW=(allocation.priority*max free/total priority)+min-bw=3000
      New BW=min(newBw, proposedBw)=min(3000, 3000)=3000
   Link D2:
      Found 2 allocation(s) on link:
      Allocation IDDC:
         Has not been adjusted: adding priority (5), minimum bandwidth will be taken as minimum (min-bw=1000)
      Allocation IDAC:
         Has not been adjusted: adding priority (4), minimum bandwidth will be taken as minimum (min-bw=1000)
      Total min used=2000, Max available=5000
      Max free=max available−total min used=3000, Total priority=9, Min bw=1000
      Proposed BW=(allocation.priority*max free/total priority)+min-bw=2667
      New BW=min(newBw, proposedBw)=min(3000, 2667)=2667
Allocating Pending request, bandwidth available: (new bw=2667)

3. ID_BD:
Analysing allocation:
NwoRequest: id=IDBD ClientB to ClientD (Min: 1000 Pref: 3000 kbps, P=5)
NwoAlloc: id=IDBD bw=1556 st=ALLOCATED
Using path: B1,C1,E2,
New bw: 3000
   Link B1:
      Found 1 allocation(s) on link:
      Allocation IDBD:
         Has not been adjusted: adding priority (5), minimum bandwidth will be taken as minimum (min-bw=1000)
      Total min used=1000, Max available=10000
      Max free=max available−total min used=9000, Total priority=5, Min bw=1000
      Proposed BW=(allocation.priority*max free/total priority)+min-bw=10000
      New BW=min(newBw, proposedBw)=min(3000, 10000)=3000
   Link C1:
      Found 2 allocation(s) on link:
      Allocation IDBD:
         Has not been adjusted: adding priority (5), minimum bandwidth will be taken as minimum (min-bw=1000)
      Allocation IDAC:
         Has not been adjusted: adding priority (4), minimum bandwidth will be taken as minimum (min-bw=1000)
      Total min used=2000, Max available=3000
      Max free=max available−total min used=1000, Total priority=9, Min bw=1000
      Proposed BW=(allocation.priority*max free/total priority)+min-bw=1556
      New BW=min(newBw, proposedBw)=min(3000, 1556)=1556
   Link E2:
      Found 2 allocation(s) on link:
      Allocation IDCD:
         Has already been adjusted: not adding priority, allocated bandwidth will be taken as minimum (wont re-adjust) (bw=2091).
      Allocation IDBD:
         Has not been adjusted: adding priority (5), minimum bandwidth will be taken as minimum (min-bw=1000)
      Total min used=3091, Max available=4000
      Max free=max available−total min used=909, Total priority=5, Min bw=1000
      Proposed BW=(allocation.priority*max free/total priority)+min-bw=1909
      New BW=min(newBw, proposedBw)=min(1556, 1909)=1556
Allocation not adjusted. (new bw=1556=old bw=1556)

4. ID_AC:
Analysing allocation:
NwoRequest: id=IDAC ClientA to ClientC (Min: 1000 Pref: 3000 kbps, P=4)
NwoAlloc: id=IDAC bw=1444 st=ALLOCATED
Using path: A1,C1,D2,
New bw: 3000
   Link A1:
      Found 1 allocation(s) on link:
      Allocation IDAC:
         Has not been adjusted: adding priority (4), minimum bandwidth will be taken as minimum (min-bw=1000)
      Total min used=1000, Max available=10000
      Max free=max available−total min used=9000, Total priority=4, Min bw=1000
      Proposed BW=(allocation.priority*max free/total priority)+min-bw=10000
      New BW=min(newBw, proposedBw)=min(3000, 10000)=3000
   Link C1:
      Found 2 allocation(s) on link:
      Allocation IDBD:
         Has already been adjusted: not adding priority, allocated bandwidth will be taken as minimum (wont re-adjust) (bw=1556).
      Allocation IDAC:
         Has not been adjusted: adding priority (4), minimum bandwidth will be taken as minimum (min-bw=1000)
      Total min used=2556, Max available=3000
      Max free=max available−total min used=444, Total priority=4, Min bw=1000
      Proposed BW=(allocation.priority*max free/total priority)+min-bw=1444
      New BW=min(newBw, proposedBw)=min(3000, 1444)=1444
   Link D2:
      Found 2 allocation(s) on link:
      Allocation IDDC:
         Has already been adjusted: not adding priority, allocated bandwidth will be taken as minimum (wont re-adjust) (bw=2667).
      Allocation IDAC:
         Has not been adjusted: adding priority (4), minimum bandwidth will be taken as minimum (min-bw=1000)
      Total min used=3667, Max available=5000
      Max free=max available−total min used=1333, Total priority=4, Min bw=1000
      Proposed BW=(allocation.priority*max free/total priority)+min-bw=2333
      New BW=min(newBw, proposedBw)=min(1444, 2333)=1444
Allocation not adjusted. (new bw=1444=old bw=1444)

Expanding

Looping through allocations:
Analysing allocation: IDCD
   Using path: D1,E2, free bandwidth=353
   Expanding allocation: allocated=2091, pref=3000, new=2444
Analysing allocation: IDDC
   Using path: E1,D2, free bandwidth=333
   Expanding allocation: allocated=2667, pref=3000, new=3000
Analysing allocation: IDBD
   Using path: B1,C1,E2, free bandwidth=0
   No spare bandwidth to expand: allocated=1556, pref=3000
Analysing allocation: IDAC
   Using path: A1,C1,D2, free bandwidth=0
   No spare bandwidth to expand: allocated=1444, pref=3000

It should be appreciated by those skilled in the art that any block diagrams herein represent conceptual views of illustrative circuitry embodying the principles of the invention. For example, a processor may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

We claim:

1. A method of managing bandwidth in a packet network carrying time sensitive data wherein sessions are established over virtual connections between respective pairs of endpoints, comprising:
for at least some of said sessions, receiving data representing local session bandwidth usage over the network at a central server;
computing global bandwidth usage data at said central server from the local session bandwidth usage data received from the endpoints; and
said server sending messages to said endpoints to allocate bandwidth to said sessions in accordance with global bandwidth demands on the network.

2. A method as claimed in claim 1, wherein said endpoints report the amount of session data being sent and the amount of session data reaching the far end endpoint of each session, and wherein said central server computes the local session bandwidth usage from said session data.

3. A method as claimed in claim 2, wherein the central server maintains a priority list allocating specific priorities to said endpoints, and wherein said central server takes into account said priority list when allocating bandwidth to said sessions.

4. A method as claimed in claim 2, wherein said central server responds to user priority requests in the allocation of session bandwidth.

5. A method as claimed in claim 1, wherein said network is an IP network.

6. A method as claimed in claim 5, wherein said endpoints communicate with said central server using an IP protocol.

7. A method as claimed in claim 1, wherein said network comprises at least two network entities with different bandwidth capabilities, and wherein said central server computes global bandwidth usage separately for said network entities and takes into account the location of the endpoints for a particular session and the bandwidth capabilities of the network entities involved in said particular session in allocating bandwidth to the endpoints.

8. A method as claimed in claim 1, wherein priority indicators are associated with at least some of said endpoints, and said central server takes into account said priority indicators in allocating bandwidth, whereby endpoints with a higher priority take precedence over endpoints with a lower priority.

9. A method as claimed in claim 8, wherein said priority indicators are user defined.

10. A method as claimed in claim 9, wherein said priority indicators are defined by location of the endpoint.

11. A method as claimed in claim 1, wherein said central server takes into account time of day in allocating bandwidth.

12. A method as claimed in claim 1, wherein the central server allocates bandwidth separately to each endpoint of a session so that bandwidth allocation can be different in opposite directions.

13. A method as claimed in claim 12, wherein only one of a pair of endpoints establishes communication with said central server and said central server sends bandwidth allocation messages for both the endpoints of said pair to said one of said pair, and said one endpoint sends the allocation data to the other endpoint over the session connection.

14. A bandwidth manager for a packet network carrying time sensitive data wherein sessions are established over virtual connections between respective pairs of endpoints, comprising:
a network interface for receiving data representing local session bandwidth usage over the network for at least some of said sessions;
a processor configured to compute global bandwidth usage based on the local session bandwidth usage data from the endpoints; and
said processor being configured to send messages to said endpoints to allocate bandwidth to said sessions in accordance with global bandwidth demands on the network.

15. A bandwidth manager as claimed in claim 14, wherein said processor is configured to receive the amount of session data being sent and the amount of session data reaching the far end endpoint of each session and compute the local session bandwidth usage from said session data.

16. A bandwidth manager as claimed in claim 15, further comprising a memory storing a priority list allocating specific priorities to said endpoints, and wherein said processor takes into account said priority list when allocating bandwidth to said sessions.

17. A bandwidth manager as claimed in claim 15, wherein said processor is configured to respond to user priority requests in the allocation of session bandwidth.

18. A bandwidth manager as claimed in claim 14, wherein said network is an IP network.

19. A bandwidth manager as claimed in claim 18, wherein said endpoints communicate with said central server using an IP protocol.

20. A bandwidth manager as claimed in claim 14, wherein said network comprises at least two network entities with different bandwidth capabilities, and wherein said processor is configured to compute global bandwidth usage separately for said network entities and take into account the location of the endpoints for a particular session and the bandwidth capabilities of the network entities involved in said particular session in allocating bandwidth to the endpoints.

21. A bandwidth manager as claimed in claim 14, wherein priority indicators are associated with at least some of said endpoints, and said processor is configured to take into account said priority indicators in allocating bandwidth, whereby endpoints with a higher priority take precedence over endpoints with a lower priority.

22. A bandwidth manager as claimed in claim 21, wherein said priority indicators are user defined.

23. A bandwidth manager as claimed in claim 21, wherein said priority indicators are defined by location of the endpoint.

24. A bandwidth manager as claimed in claim 14, wherein said processor is configured to take into account time of day in allocating bandwidth.

25. A bandwidth manager as claimed in claim 14, wherein the processor is configured to allocate bandwidth separately to each endpoint of a session so that bandwidth allocation can be different in opposite directions.

26. A bandwidth manager as claimed in claim 14, wherein only one of a pair of endpoints establishes communication with said bandwidth manage, and said processor is configured to send bandwidth allocation messages for both the endpoints of said pair to said one of said pair, so that said one endpoint can send the allocation data to the other endpoint over the session connection.
